(19) United States
(12) Patent Application Publication
(10) Pub. No.: US 2012/0158275 A1
(43) Pub. Date: Jun. 21, 2012

(54) REAL-TIME TRAFFIC SITUATION AWARENESS SYSTEM AND METHOD THEREOF

(76) Inventors: Cheng-Wei Huang, (US); Shyi-Shing Hsieh, (US)

(21) Appl. No.: 13/167,340

(22) Filed: Jun. 23, 2011

(30) Foreign Application Priority Data
Dec. 20, 2010 (TW) 099144710

(51) Int. Cl. G08G 1/00; G01C 21/36

(52) U.S. Cl. 701/119; 701/117

(57) ABSTRACT

The disclosure provides a real-time traffic situation awareness system. In one embodiment, the real-time traffic situation awareness system receives driving data from a car, wherein the driving data comprises an image, GPS data, and gyroscope sensor data. The real-time traffic situation awareness system comprises an image processing unit, a feature extraction unit, a feature matrix database, a data grouping unit, and a situation awareness unit. The image processing unit processes the image to generate a processed image. The feature extraction unit generates a data point according to the processed image, the GPS data, and the gyroscope sensor data. The data grouping unit searches the feature matrix database for a plurality of feature groups of an optimal feature matrix corresponding to a geographic area according to the GPS data of the data point. The situation awareness unit analyzes the feature groups to generate traffic information.

### CROSS REFERENCE TO RELATED APPLICATIONS

This application claims priority of Taiwan Patent Application No. 099144710, filed on Dec. 20, 2010, the entirety of which is incorporated by reference herein.

### BACKGROUND

1. Technical Field

The disclosure relates to traffic computer systems, and more particularly to computer systems for real-time traffic situation awareness.

2. Description of the Related Art

Current driving guide systems provide real time traffic information for drivers, such as information about car speeds on specific road sections, road sections under construction, and road sections with car accidents. Generally, the traffic information provided by ordinary driving guide systems is derived from public information provided by the government. For example, the government may set vehicle detectors under road surfaces to count the traffic flow to obtain traffic information. The cost for setting the vehicle detectors, however, is high, leading to lack of vehicle detectors due to economic considerations. The government may also set video cameras to monitor traffic situations on road sections. The video cameras, however, are only set on road intersections and cannot provide enough full-scale traffic information. Thus, an efficient and economical method for providing real-time traffic information for drivers is therefore required.

A driving recorder is an apparatus installed on a car to record video images when a user is driving the car. A global positioning system (GPS) can provide accurate positioning information of a car. If a car is equipped with a driving recorder and a GPS module, the real-time image provided by the driving recorder and the positioning data provided by the GPS module can be taken as a source from which real-time traffic information is derived. If a great amount of real-time image and positioning data generated by many cars are integrated and combined, useful real-time traffic information is generated and provided to drivers of cars.

### SUMMARY

The disclosure provides a real-time traffic situation awareness system. In one embodiment, the real-time traffic situation awareness system receives driving data from a car, wherein the driving data comprises an image, GPS data, and gyroscope sensor data. The real-time traffic situation awareness system comprises an image processing unit, a feature extraction unit, a feature matrix database, a data grouping unit, and a situation awareness unit. The image processing unit processes the image to generate a processed image. The feature extraction unit generates a data point according to the processed image, the GPS data, and the gyroscope sensor data. The feature matrix database stores a plurality of feature matrixes of a plurality of data groups corresponding to a plurality of geographic areas. The data grouping unit searches the feature matrix database for a plurality of feature groups of an optimal feature matrix corresponding to a geographic area near to that of the data point according to the GPS data of the data point. The situation awareness unit analyzes the feature groups according to a plurality of situation awareness rules to generate traffic information.

The disclosure also provides a real-time traffic situation awareness method. In one embodiment, a real-time traffic situation awareness system comprises an image processing unit, a feature extraction unit, a feature matrix database, a data grouping unit, and a situation awareness unit. First, driving information is received from a car, wherein the driving information comprises an image, GPS data, and gyroscope sensor data. The image is then processed with the image processing unit to generate a processed image. A data point is then generated with the feature extraction unit according to the processed image, the GPS data, and the gyroscope sensor data. A plurality of feature matrixes of a plurality of data groups corresponding to a plurality of geographic areas is then stored with the feature matrix database. The feature matrix database is then searched for a plurality of feature groups of an optimal feature matrix corresponding to a geographic area near to that of the data point with the data grouping unit according to the GPS data of the data point. The feature groups are then analyzed with the situation awareness unit according to a plurality of situation awareness rules to generate traffic information.

The disclosure provides a guiding apparatus. In one embodiment, the guiding apparatus is installed on a car and comprises an image sensor, a GPS module, a gyroscope sensor, a wireless transceiver, a processor, a roadmap database, and a screen. The image sensor detects an image. The GPS module generates GPS data. The gyroscope sensor detects a 3-dimensional gravity operation of a car to generate gyroscope sensor data comprising acceleration data and angle acceleration data of the car. The wireless transceiver is coupled to a wireless network and connects the guiding apparatus to a real-time traffic situation awareness system via the wireless network. The processor gathers the image, the GPS data, and the gyroscope sensor data to generate driving information, and directs the wireless transceiver to send the driving information to the real-time traffic situation awareness system. The roadmap database stores a roadmap. The wireless transceiver receives traffic information from the real-time traffic situation awareness system, the processor generates guiding information according to the traffic information, and the screen shows the guiding information and the roadmap thereon.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a block diagram of a system comprising a real-time traffic situation awareness system according to the disclosure;

FIG. 2 is a block diagram of a real-time traffic situation awareness system according to the disclosure;

FIG. 3 is a flowchart of a real-time traffic situation awareness method according to the disclosure;

FIG. 4 is a schematic diagram of a data structure of data points according to the disclosure;

FIG. 5 is a schematic diagram of data points of a classified data group for performing data training according to the geographical areas according to the disclosure;

FIG. 6 is a schematic diagram of a principle component analysis performed according to the disclosure;

FIG. 7 is a schematic diagram of a linear discrimination analysis performed according to the disclosure;

FIG. 8 is a schematic diagram of generation of traffic information with situation awareness techniques according to the disclosure; and

FIG. 9 is a block diagram of a guiding apparatus installed on a car according to the disclosure.

### DETAILED DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides a real-time traffic situation awareness system. The real-time traffic situation awareness system analyzes a great amount of real-time image data to generate useful data points, and then compiles statistics of the data points via data learning of artificial intelligence to generate real-time traffic information. The real-time traffic information generated by the real-time traffic situation awareness system is sent back to driving guide systems installed on the cars. The driving guide systems on the cars can then estimate required travel time period of road sections, determine road situations, and other real-time information such as road sections under construction according to the real-time traffic information. In addition, the real-time information provided by the real-time traffic situation awareness system also comprises calibration information for a GPS apparatus to fix positioning data provided by a global positioning system (GPS) which may have signal loss or drift due to city obstacles such as tunnels and overpasses.

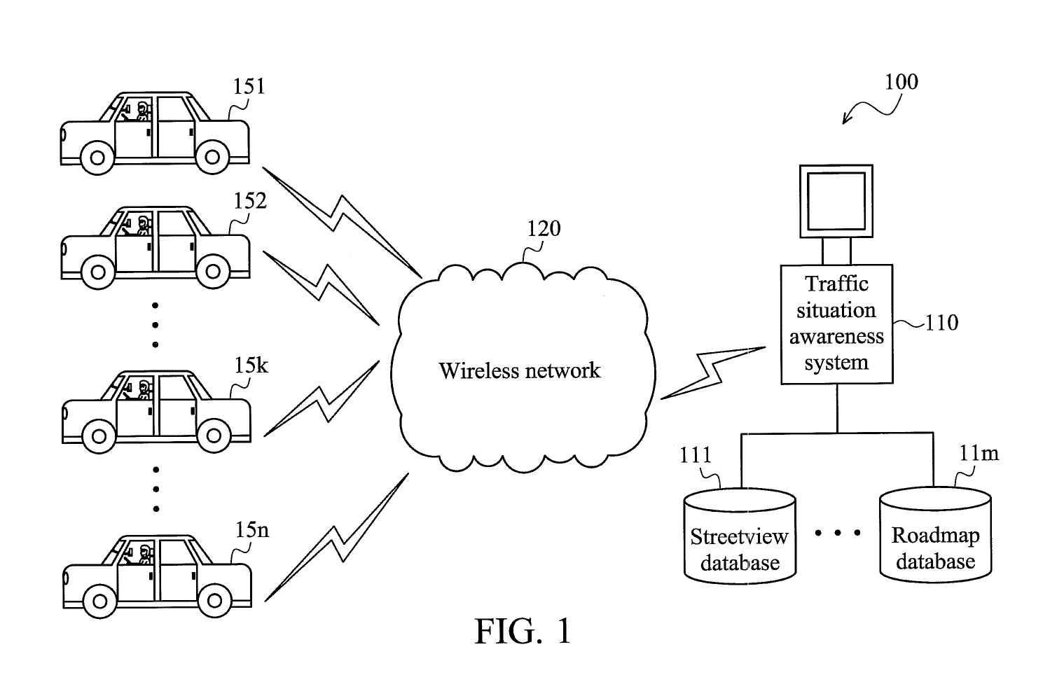

Referring to FIG. 1, a block diagram of a system 100 comprising a real-time traffic situation awareness system 110 according to the disclosure is shown. A plurality of cars 151˜15n are equipped with driving recorders for recording real-time video images, GPS modules for generating positioning data of the cars, and gyroscope sensors for providing 3-dimensional gravity sense information of the cars. When the cars 151˜15n are driven on the roads, the cars 151˜15n combine video images generated by driving recorders, positioning data generated by GPS modules, and gyroscope sensor data generated by gyroscope sensors to obtain driving information, and sends the driving information to the traffic situation awareness system 110 via the wireless network 120. The traffic situation awareness system 110 is coupled to a plurality of databases comprising a street view database 111 and a roadmap database 11m. The traffic situation awareness system 110 gathers driving information of the cars 151˜15n via the wireless network 120, converts the driving information to a plurality of data points available for the traffic situation awareness system 110, and processes the data points with feature dimension lowering techniques or data grouping techniques to generate an optimal feature matrix. When the traffic situation awareness system 110 receives new driving information, a data group which the new driving information belongs to is rapidly found according to the optimal feature matrix, and new traffic information is generated according to the situation awareness techniques. The traffic information generated by the traffic situation awareness system 110 is then forwarded back to the cars 151˜15n to guide the cars 151˜15n to their targeted locations.

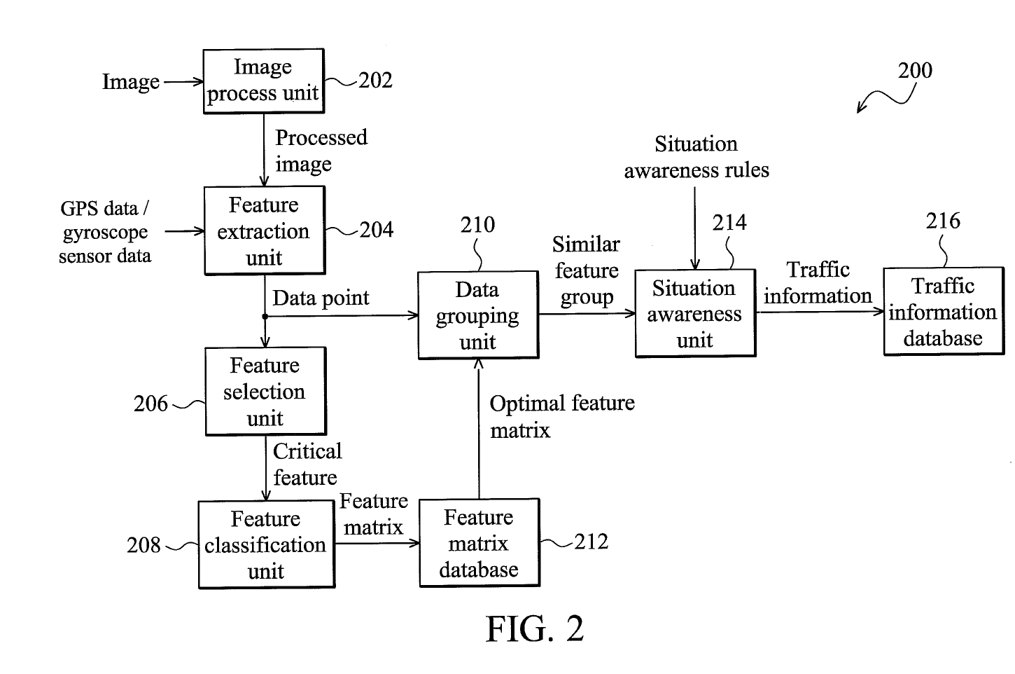

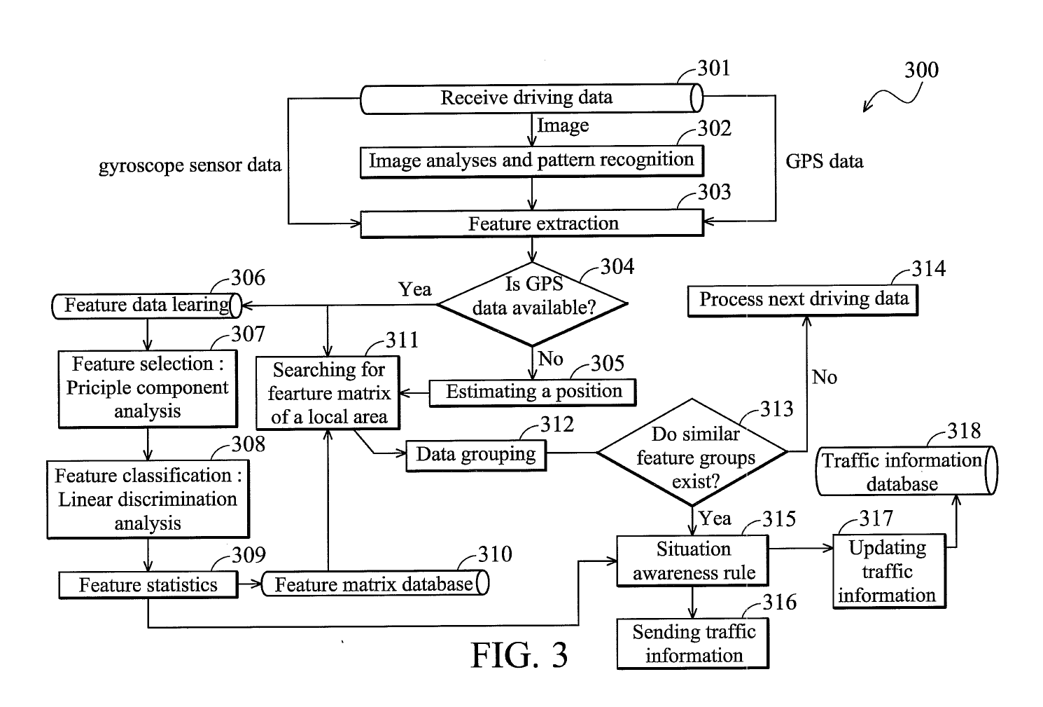

Referring FIG. 2, a block diagram of a real-time traffic situation awareness system 200 according to the disclosure is shown. In one embodiment, the traffic situation awareness system 200 comprises an image processing unit 202, a feature extraction unit 204, a feature selection unit 206, a feature classification unit 208, a feature matrix database 212, a data grouping unit 210, a situation awareness unit 214, and traffic information database 216. Referring to FIG. 3, a flowchart of a real-time traffic situation awareness method 300 according to the disclosure is shown. The traffic situation awareness system 200 operates according to the method 300 to generate real-time traffic information. First, the traffic situation awareness system 200 receives driving data from a car (step 301), wherein the driving data comprises an image, GPS data, and gyroscope sensor data. In one embodiment, the GPS data is generated by a GPS module installed on the car.

The image processing unit 202 then analyzes the video image of the driving data to generate a processed image (step 302). In one embodiment, the image processing unit 202 processes the image of the driving data with a pattern recognition process to find road marks existing in the image to generate the processed image. In one embodiment, the road marks comprise traffic lights, signboards, road signs, and buildings. For example, the traffic lights and the signboards can be identified from the image according to the colors and shapes of the traffic lights and the signboards. In addition, an object tracking technique is used to trace road marks from image data. Furthermore, buildings are identified from images according to edge detection and corner detection techniques.

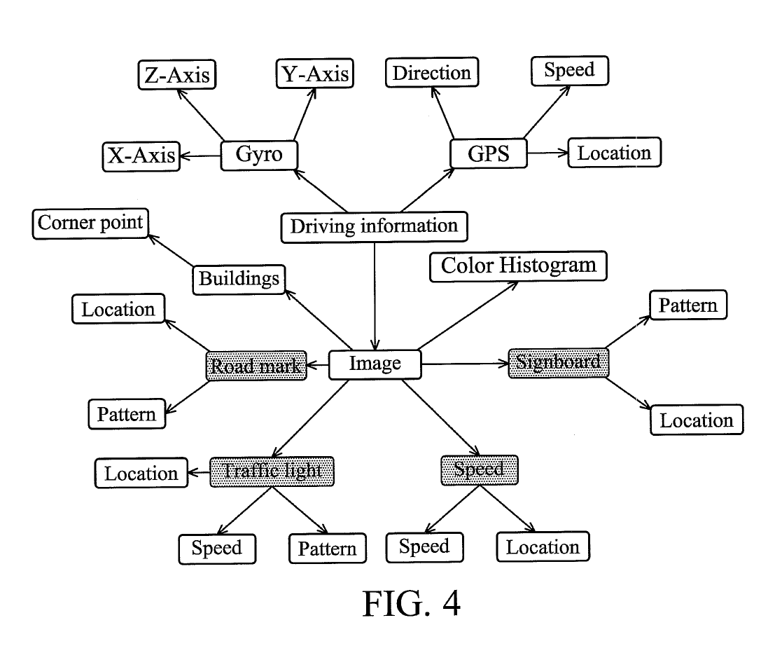

The feature extraction unit 204 then combines the processed image generated by the image processing unit 202 with the GPS data and the gyroscope sensor data of the driving data to generate a data point available for the system 200, wherein the data point comprises information about location, speed, acceleration, angular acceleration, and direction of the car and a corresponding timestamp. Referring to FIG. 4, a schematic diagram of a data structure of data points according to the disclosure is shown. In one embodiment, the driving information received from a car comprises image data, GPS positioning data, and gyroscope sensor data (Gyro data). GPS data is converted to location, speed, and direction data. Gyroscope sensor data is converted to speed, acceleration, and angular acceleration on an X, Y, and Z axis. Image data is converted by the image processing unit 202 to road marks, traffic lights, buildings, and signboards, each of which comprises information about patterns, locations, and colors.

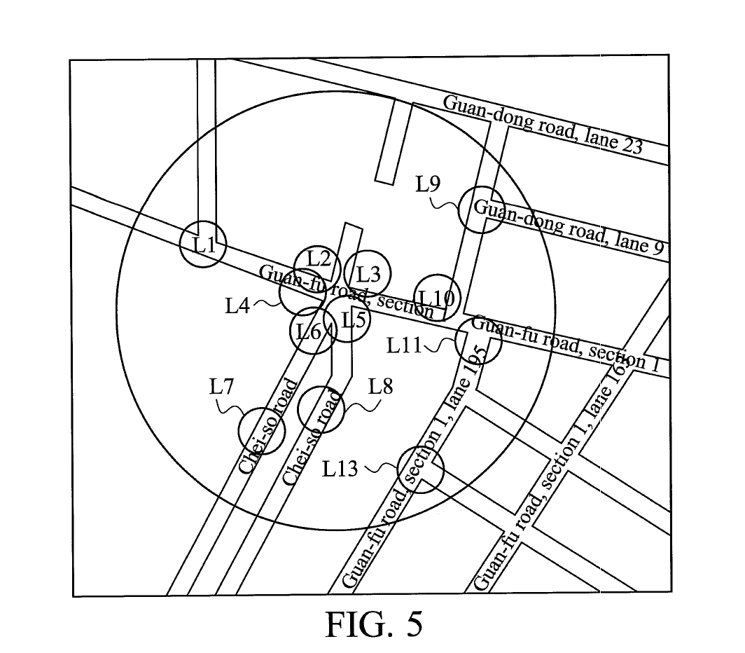

If the data point comprises available GPS data (step 304), the data point is sent to the feature selection unit 206 as a source for feature data learning (step 306). The feature selection unit 206 performs a data training process on the received data to generate matrixes for rapid calculation. The data training process comprises training of a single road point and a trace of a road section. When a new data point is added to a database for data training, the feature selection unit 206 generates a weight for the new data point according to a timestamp of the new data. When the data training process begins, the feature selection unit 206 classifies the new data point according to GPS data of the new data point, gathers past data points neighboring to the new data point from the training database, and performs the data training process on the new data point and the past data points to generate a classified data group. Referring to FIG. 5, a schematic diagram of data points of a classified data group for performing data training according to the geographical areas according to the disclosure is shown. The feature selection unit 206 gathers data groups L1˜L13 in neighboring areas to lower the data range for calculation, thereby increasing accuracy for subsequent feature selections, which are used as a basis for data training.

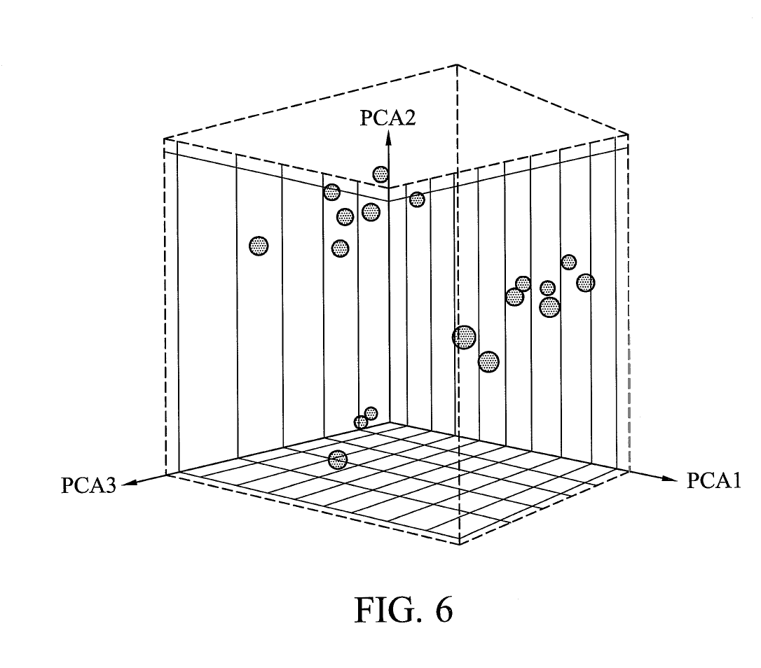

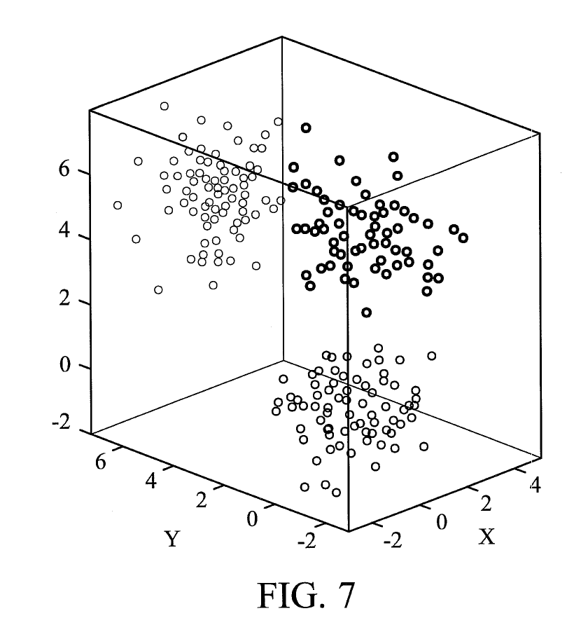

The feature selection unit 206 then generates weights of data points according to timestamps of the data points, and updates the data of the classified data group according to the weights. The earlier the timestamps of the data points are, the lower the weights of the data points are. The feature selection unit 206 then analyzes the data points of the classified data group to extract critical features, thereby lowering data dimensions and increasing data processing speed. In one embodiment, the feature selection unit 206 performs a principle component analysis (PCA) on the data points of the classified data group to generate the critical features. Referring to FIG. 6. a schematic diagram of the principle component analysis performed according to the disclosure is shown. When the principle component analysis is performed, a plurality of critical features PCA1, PCA2, and PCA3 are obtained according to the data points of the classified data group. The feature classification unit 208 then performs a linear discrimination analysis (LDA) on the data points to obtain a feature matrix of the classified data group (step 308). Referring to FIG. 7, a schematic diagram of a linear discrimination analysis performed according to the disclosure is shown. Finally, the feature classification unit 208 stores the feature matrix to the feature matrix database 212 according to the geographical area of the classified data group (steps 309 and 310). Thus, the feature matrix database 212 stores a plurality of feature matrixes of a plurality of classified data groups respectively corresponding to a plurality of geographical areas.

Because the data points taken as an input to the traffic situation awareness system 200 are divided into a plurality of classified data groups according to the geographical areas of the data points, the traffic situation awareness system 200 can performs statistic processes such as data training, principle component analysis, and linear discrimination analysis to derive the feature matrixes which are to be stored to the feature matrix data base 212 from the classified data groups, wherein the feature matrixes respectively correspond to the classified data groups. When the feature extraction unit 204 generates a new data point, the data grouping unit 210 searches the feature matrix database 212 according to the geographical area of the new data point (step 311) to obtain a calculation matrix near the geographical area of the new data point, and then calculates a similar feature group of the new data point (step 312). If the data grouping unit 210 can successfully find a similar feature group corresponding to the new data point from the feature matrix database 212 (step 313), the situation awareness unit 214 then analyzes the statistics data of the similar feature group according to a plurality of situation awareness rules to obtain traffic information corresponding to the geographical area of the new data point (step 315).

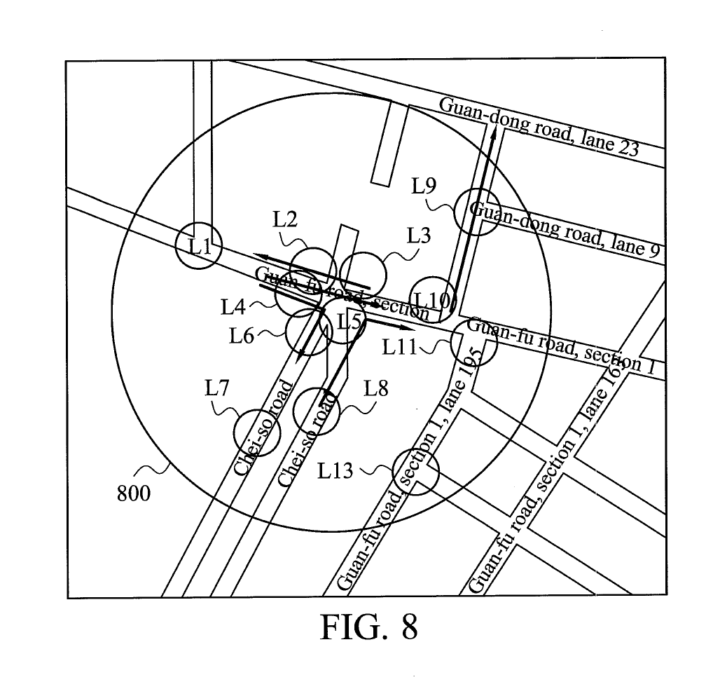

Referring to FIG. 8, a schematic diagram of generation of traffic information with situation awareness techniques according to the disclosure is shown. The situation awareness unit 214 analyzes data of a similar feature group corresponding to the geographical area 800 to generate traffic information. For example, the situation awareness unit 214 analyzes groups with neighboring geographical areas L2˜L6, and determines whether an intersection is a one-way traffic street or a two-way traffic street according to statistics of traffic direction at the intersection. The traffic situation awareness system then sends the traffic information generated by the situation awareness unit 214 back to the cars via the wireless network to guide the cars (step 316). Otherwise, the traffic situation awareness system stores the traffic information generated by the situation awareness unit 214 in the traffic information database 216 (step 318), thereby updating the traffic information stored in the traffic information database 216 (step 317).

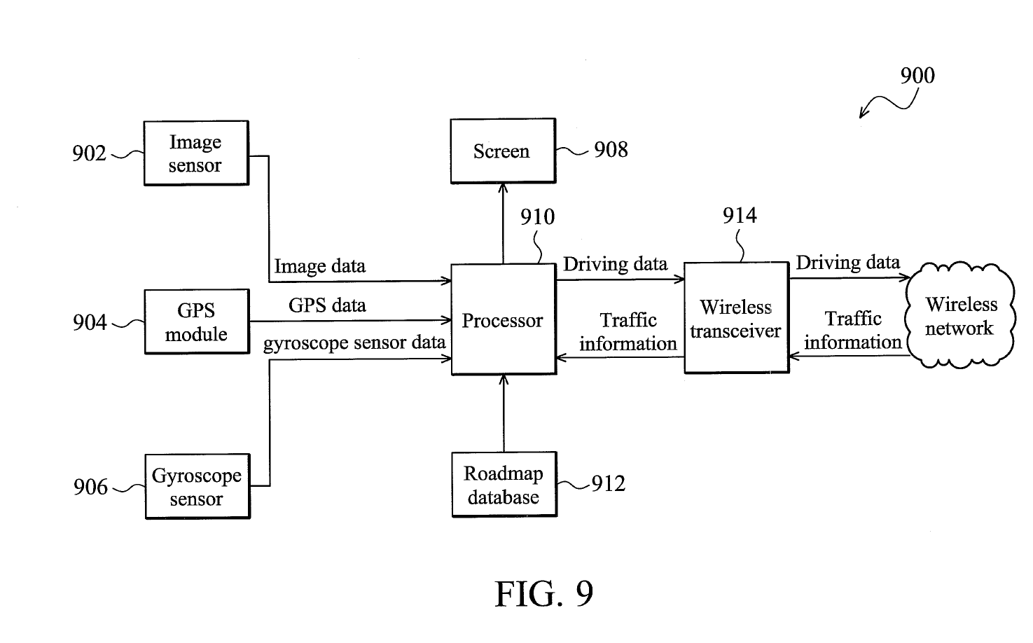

Referring to FIG. 9, a block diagram of a guiding apparatus 900 installed on a car according to the disclosure is shown. In one embodiment, the guiding apparatus 900 comprises an image sensor 902, a GPS module 904, a gyroscope sensor 906, a screen 908, a processor 910, a roadmap database 912, and a wireless transceiver 914. The image sensor 902 detects an image to be sent to the processor 910. The GPS module 904 generates GPS data to be sent to the processor 910. The gyroscope sensor 906 generates gyroscope sensor data to be sent to the processor 910. The processor 910 integrates the image, the GPS data, and the gyroscope sensor data to obtain driving data, and sends the driving data to the wireless transceiver 914. The wireless transceiver 914 is coupled to a wireless network, and sends the driving data to a traffic situation awareness system via the wireless network. The wireless transceiver 914 also receives traffic information from the traffic situation awareness system via the wireless network, and sends the traffic information to the processor 910. The processor 910 then directs the screen 908 to show the traffic information on a roadmap retrieved from a roadmap database 912 as reference for a driver of a car.

While the disclosure has been described by way of example and in terms of embodiments, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A real-time traffic situation awareness system, receiving driving data from a car, wherein the driving data comprises an image, GPS data, and gyroscope sensor data, comprising:
an image processing unit, processing the image to generate a processed image;
a feature extraction unit, generating a data point according to the processed image, the GPS data, and the gyroscope sensor data;
a feature matrix database, storing a plurality of feature matrixes of a plurality of data groups corresponding to a plurality of geographic areas;
a data grouping unit, searching the feature matrix database for a plurality of feature groups of an optimal feature matrix corresponding to a geographic area near to that of the data point according to the GPS data of the data point; and
a situation awareness unit, analyzing the feature groups according to a plurality of situation awareness rules to generate traffic information.

2. The real-time traffic situation awareness system as claimed in claim 1, wherein the real-time traffic situation awareness system further comprises:
a feature selection unit, finding a plurality of past data points corresponding to geographical areas near to that of the data point according to the GPS data of the data point, combining the past data points with the data point to obtain a data group, and analyzing the data group to obtain a plurality of critical features; and
a feature classification unit, performing a linear discrimination analysis (LDA) on the critical features to generate a feature matrix to be stored to the feature matrix database.

3. The real-time traffic situation awareness system as claimed in claim 1, wherein the real-time traffic situation awareness system further comprises:
traffic information database, storing the traffic information generated by the situation awareness unit according to the geographic location of the traffic information.

4. The real-time traffic situation awareness system as claimed in claim 1, wherein the real-time traffic situation awareness system sends the traffic information back to the car to guide the car to a targeted location.

5. The real-time traffic situation awareness system as claimed in claim 1, wherein the image processing unit uses a pattern recognition process to find a plurality of road mark features comprised by the image, thereby generating the image information.

6. The real-time traffic situation awareness system as claimed in claim 5, wherein the road mark features comprise traffic lights, signboards, road marks, road signs, and buildings.

7. The real-time traffic situation awareness system as claimed in claim 2, wherein the feature selection unit performs a principle component analysis (PCA) on the data group to generate the critical features.

8. The real-time traffic situation awareness system as claimed in claim 2, wherein the feature selection unit generates a weight according to a timestamp of the data point, and updates the data group according to the weight and the data point, wherein the weight is small when the timestamp is early.

9. The real-time traffic situation awareness system as claimed in claim 1, wherein the traffic information comprises calibration information of the GPS data, a road situation of a route passed by a car, and a traveling time period required by the car to move to a targeted location.

10. A real-time traffic situation awareness method, wherein a real-time traffic situation awareness system comprises an image processing unit, a feature extraction unit, a feature matrix database, a data grouping unit, and a situation awareness unit, comprising:
receiving driving information from a car, wherein the driving information comprises an image, GPS data, and gyroscope sensor data;
processing the image with the image processing unit to generate a processed image;
generating a data point with the feature extraction unit according to the processed image, the GPS data, and the gyroscope sensor data;
storing a plurality of feature matrixes of a plurality of data groups corresponding to a plurality of geographic areas with the feature matrix database;
searching the feature matrix database for a plurality of feature groups of an optimal feature matrix corresponding to a geographic area near to that of the data point with the data grouping unit according to the GPS data of the data point; and
analyzing the feature groups with the situation awareness unit according to a plurality of situation awareness rules to generate traffic information.

11. The real-time traffic situation awareness method as claimed in claim 10, wherein the real-time traffic situation awareness system further comprises a feature selection unit and a feature classification unit, and the real-time traffic situation awareness method further comprises:
finding a plurality of past data points corresponding to the geographical areas near to that of the data point with the feature selection unit according to the GPS data of the data point;
combining the past data points with the data point to obtain a data group;
analyzing the data group with the feature selection unit to obtain a plurality of critical features; and
performing a linear discrimination analysis (LDA) on the critical features with the feature classification unit to generate a feature matrix to be stored to the feature matrix database.

12. The real-time traffic situation awareness method as claimed in claim 10, wherein the real-time traffic situation awareness method further comprises:
sending the traffic information back to the car to guide the car to a targeted location.

13. The real-time traffic situation awareness method as claimed in claim 10, wherein processing of the image comprises:
finding a plurality of road mark features comprised by the image via a pattern recognition process to generate the image information.

14. The real-time traffic situation awareness method as claimed in claim 13, wherein the road mark features comprise traffic lights, signboards, road marks, road signs, and buildings.

15. The real-time traffic situation awareness method as claimed in claim 11, wherein generating of the critical features comprise:
performing a principle component analysis (PCA) on the data group with the feature selection unit to generate the critical features.

16. The real-time traffic situation awareness method as claimed in claim 11, wherein the real-time traffic situation awareness method further comprises:
generating a weight according to a timestamp of the data point, wherein the weight is small when the timestamp is early; and
updating the data group according to the weight and the data point.

17. The real-time traffic situation awareness method as claimed in claim 10, wherein the traffic information comprises calibration information of the GPS data, a road situation of a route passed by the car, and a traveling time period required by the car to move to a targeted location.

18. A driving guide apparatus, installed on a car, comprising:
an image sensor, detecting an image;
a GPS module, generating GPS data;
a gravity sensor, detecting a 3-dimensional gravity operation of the car to generate gravity data comprising acceleration data and angle acceleration data of the car;
a wireless transceiver, coupled to a wireless network, connecting the guiding apparatus to a real-time traffic situation awareness system via the wireless network; and
a processor, gathering the image, the GPS data, and the gravity data to generate driving information, and directing the wireless transceiver to send the driving information to the real-time traffic situation awareness system.

19. The driving guide apparatus as claimed in claim 18, wherein the driving guide apparatus further comprises:
a roadmap database, storing a roadmap; and
a screen,
wherein the wireless transceiver receives traffic information from the real-time traffic situation awareness system, the processor generates guiding information according to the traffic information, and the screen shows the guiding information and the roadmap thereon.
